(19) United States
(12) Patent Application Publication
(10) Pub. No.: US 2024/0179366 A1
(43) Pub. Date: May 30, 2024

(54) MUTABLE COMPOSITE MEDIA

(71) Applicant: Claps Artificial Intelligence Inc., New York, NY (US)

(72) Inventors: Jacob Lewis, New York, NY (US); Jose Manuel Gonzalez de Rueda, Madrid (ES)

(21) Appl. No.: 18/070,152

(22) Filed: Nov. 28, 2022

(51) Int. Cl. H04N 21/431; G06F 3/14; H04N 5/265; H04N 21/4545

(52) U.S. Cl. CPC H04N 21/4316; G06F 3/14; H04N 5/265; H04N 21/45457

(57) ABSTRACT

Rendering mutable composite media is disclosed, including: storing a composite media including a set of slides, a user overlay video, and a set of presentation metadata, wherein the set of presentation metadata relates one or more slides to the user overlay video; and rendering the composite media including: using the set of presentation metadata to generate an image including a relevant portion of the set of slides; and overlaying at least a portion of the user overlay video on the image including the relevant portion of the set of slides.

### BACKGROUND OF THE INVENTION

Creating video presentations can be an inefficient process for users because a user would need to start from scratch for each instance of recording a video. Creating a video presentation requires generating a document, recording a video that shows the document, and then editing the video presentation. Even creating a one-minute video presentation can easily take an hour to complete the three stages of production. However, during conventional post recording editing of a video presentation, certain elements of the video, such as what is shown in the document, cannot be easily changed.

### BRIEF DESCRIPTION OF THE DRAWINGS

Various embodiments of the invention are disclosed in the following detailed description and the accompanying drawings.

FIG. 1 is an embodiment of a system for mutable composite media.

FIG. 2 is a diagram showing an example of a device.

FIG. 3 is a flow diagram showing an embodiment of a process for rendering a mutable composite media.

FIG. 4 is a diagram showing an example of a user interface that is presented at a display screen of a device while a user is recording a video presentation of a set of slides.

FIG. 5 is a flow diagram showing an example of a process for rendering a mutable composite media.

FIG. 6 is a flow diagram showing an example of a process for receiving edits to underlying assets associated with a composite media.

FIG. 7 is a diagram showing three examples of sets of slides as they are being edited at a user interface.

FIG. 8 is a diagram showing an example of a user interface for editing the time alignment between a user overlay video and the presentation of a set of slides associated with a composite media.

FIG. 9 is a flow diagram showing an example process for rendering a composite media to play a video presentation at a display screen of a device.

FIG. 10 is a flow diagram showing an example process for exporting a composite media to generate a video presentation in a manner that is hidden from a display screen of a device.

FIG. 11 is a flow diagram showing an example process for efficiently sharing a composite media.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Embodiments of mutable composite media are described herein. A composite media including a set of slides, a user overlay video, and a set of presentation metadata is stored. In various embodiments, a “set of slides” comprises any document with a set of one or more pages/portions that can be referred to as “slides.” For example, a set of slides may comprise a slide deck (with one or more slides), a document (with one or more pages), or a video (with one or more video frames). In various embodiments, a composite media refers to a recording of a user overlay video along with a concurrent presentation of slides of the set of slides. The set of presentation metadata relates one or more slides to the user overlay video. In various embodiments, the set of presentation metadata describes how the set of slides were presented by a user (e.g., a creator of the presentation) during the recording of the user overlay video. In some embodiments, the set of presentation metadata further describes user actions that were performed during the recording of the user overlay video and that were independent of the slides (e.g., the addition of music or a video filter during the recording). The composite media is rendered. The rendering of the composite media includes using the set of presentation metadata to generate an image including a relevant portion of the set of slides. The rendering of the composite media further includes overlaying at least a portion of the user overlay video on the image that was generated from the relevant portion of the set of slides.

As will be described in further detail below, after the initial recording (e.g., by a creator user) of a video presentation comprising a user overlay video concurrently with a presentation of a set of slides, a set of presentation metadata associated with the presentation of the slides is stored separately from the set of slides as well as the user overlay video. The user overlay video, the set of presentation metadata, and the set of slides of that recording form the underlying assets of a composite media (a logical construct) that corresponds to that video presentation recording. Thereafter, any one or more of the user overlay video, the set of presentation metadata, and the set of slides associated with the composite media can be separately edited (e.g., by the creator user or another user) before a video presentation is rendered to be played at a user display or exported in a manner that is hidden from a user display based on the edited versions, if any, of the user overlay video, the set of presentation metadata, and the set of slides. By separately storing the user overlay video, the set of presentation metadata, and the set of slides as assets of a composite media, each asset can potentially be shared with a different user and/or individually edited such that the assets, inclusive of any edits that were made after their initial creation/recording, can be rendered into an updated (e.g., refined) version of the video presentation that may differ from the original video presentation that was recorded.

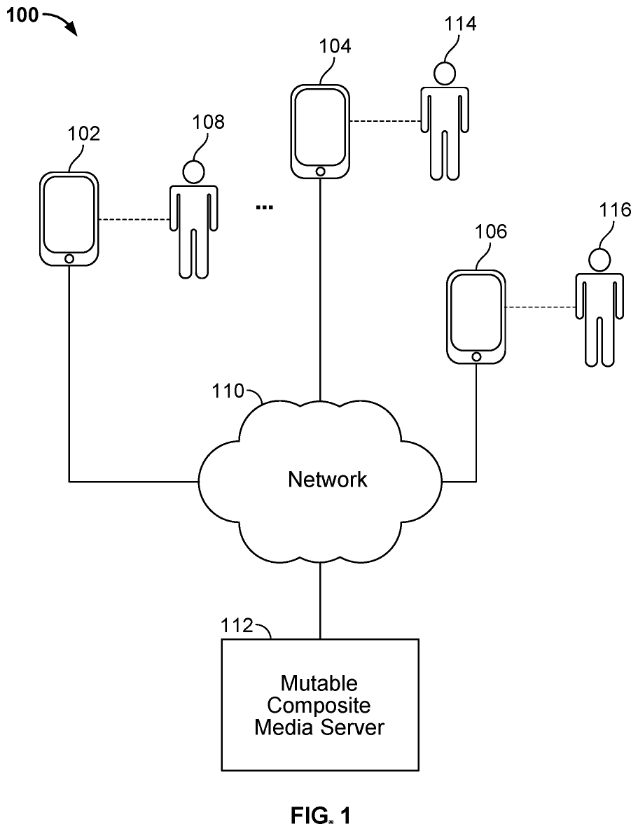

FIG. 1 is an embodiment of a system for mutable composite media. System 100 includes device 102, device 104, device 106, network 110, and mutable composite media server 112. Network 110 includes data and/or telecommunications networks. Each of device 102, device 104, device 106, and mutable composite media server 112 communicates with each other over network 110.

Each of devices 102, 104, and 106 is a device that includes a microphone that is configured to record audio, such as speech, that is provided by user 108. In some embodiments, each of devices 102, 104, and 106 also includes a camera or other sensor that is configured to record a video of respective users 108, 114, and 116. Examples of each of devices 102, 104, and 106 include a smart phone, a tablet device, a laptop computer, a desktop computer, or any networked device. In various embodiments, user 108 selects a software application (not shown) for programmatic audio and/or video stream editing to execute at a device such as device 102. The software application is configured to provide a user interface that allows user 108 to select a set of slides and then record a video presentation, including a user feed video (e.g., using the front-facing camera of the device) and a transition through at least a portion of the set of slides. In various embodiments, each slide (or portion/page) of the set of slides is stored as a respective object associated with the set of slides and also, each element that is included in each slide is also stored as a separate object associated with that slide. For example, a set of slides may be associated with a template, which specifies preselected attributes (e.g., background color, font type, font size) of elements to be applied to the user added elements to slides of the set. Also, for example, a stored object associated with a slide in a set may include information, such as a slide identifier (e.g., a unique string) and a version. Furthermore, a stored object associated with each element on a slide may include an element type (e.g., a title structure, an image structure, a bullet structure), an element identifier, and element-related content (e.g., a title string, image data, bullet point strings).

During the video presentation associated with a selected set of slides, a video feed of user 108 as recorded by a camera of device 102 may show user 108 presenting the content shown on one or more slides of the selected set of slides. In various embodiments, the video feed of a user in association with a video presentation is referred to as a “user overlay video” because a (e.g., cropped) version of the video will be displayed over (on top of) slides(s) of the set in a rendered playback or exported video file derived from the composite media associated with the video presentation. Furthermore, during the video presentation, user 108 can transition from slide to slide within the set, interact with a currently presented slide, and/or perform an action that modifies the user's video feed. Each of user 108's presentation actions during the recorded video presentation is stored as part of a set of presentation metadata, which is an underlying asset of a composite media (a logical construct, such as an object, for example) that is associated with that recorded video presentation. The set of presentation metadata stores timestamps (e.g., in the original recorded video presentation) at which different slides were presented and also timestamps of recorded user actions that were made during the original recorded video presentation. A user action could be an interaction with an element on a slide, such as, for example, selecting or zooming in on that element. Because, as mentioned above, in various embodiments, the elements of each slide are stored as separate objects, a recorded user action may be associated with a specific element (e.g., a title, a bullet string, or an image) of the slide with which a specified action was taken.

After the video presentation associated with the selected set of slides is recorded by device 102, in some embodiments, device 102 is configured to locally store the underlying assets of the composite media associated with the video presentation and to also send a copy of those underlying assets to mutable composite media server 112 over network 110. The underlying assets of the composite media include the set of slides, the user overlay video, and the set of presentation metadata. Mutable composite media server 112 is configured to store the received underlying assets associated with the composite media. In various embodiments, mutable composite media server 112 is configured to present information related to the composite media at a user interface (e.g., that is presented within the software application for editing videos that is executing at devices such as devices 102, 104 and 106) that indicates that the composite media is “mutable.” In various embodiments, a composite media is “mutable” in the sense that a user can make edits to one or more of its underlying assets such that a render/playback or export of the composite media would be made based on the edited version(s), if any, of the underlying assets. In various embodiments, where a first (“creator”) user (e.g., user 108 associated with device 102) had authored the set of slides and for which a user overlay video and a set of presentation metadata were recorded for a composite media, the same user can edit one or more of the underlying assets of the composite media at the device and then associate the edited underlying asset with the same composite media. In various embodiments, while a first (“creator”) user (e.g., user 108 associated with device 102) had authored the set of slides and for which a user overlay video and a set of presentation metadata were recorded for a composite media, a different (“viewer”) user (e.g., user 114 associated with device 104 or user 116 of device 106) can request any copies of one or more of the underlying assets of the composite media from mutable composite media server 112 to edit and then associate the edited underlying asset with a new composite media. User edits to one or more underlying assets of a composite media can be stored locally at a device.

An example of an edit to the set of slides may include making a change to the elements, background, fonts, and/or content of one or more slides. An example of an edit to the user overlay video may include removing one or more segments from the overlay video. An example of an edit to the set of presentation metadata may include changing the time alignment between the presentation of slides and the user overlay. One example use case in which a creator user of the original video presentation associated with the composite media would want to edit one of the underlying assets is to make a correction (e.g., a typographical error, a background color, elements) in the slides presented in the presentation and/or to otherwise refine the overall presentation. One example use case in which a viewer user (a user other than the creator user) of the original video presentation associated with the composite media would want to edit one of the underlying assets is to copy a desired portion (e.g., slides) of that video presentation and then make incremental changes to those slides without needing to generate the slides from scratch. Put another way, the viewer user can remix underlying assets associated with a composite media that is created by another user, the creator user, to thereby become a creator on a new composite media with the remixed/edited version of that underlying asset without needing to create an entirely new video presentation.

In response to a request from a user to render the composite media for a playback of a video presentation, the device at which the request is made is configured to retrieve the locally stored underlying assets, inclusive of any edits that may have been made, and render a presentation based on the (edited) underlying assets. For example, after recording a video presentation using a set of slides at device 102, user 108 made edits to change a background color and font color in the slides of the set and then requested for the composite media associated with that recording to be rendered. Device 102 is configured to present a cropped version of the user overlay video over different images that are derived from slides of the set of slides at timestamps that are denoted in the set of presentation metadata. The resulting playback is that the same user overlay video that was originally recorded by user 108 is now overlaid on the updated slides (with the new background and font colors) at a display screen at device 102.

In response to a request to a user to export a video presentation derived from the composite media, the device at which the request is made is configured to retrieve the locally stored underlying assets, inclusive of any edits that may have been made, and generate a series of video frames of a video presentation rendered based on the (edited) underlying assets. Instead of presenting at a display screen of the device an overlay of a cropped version of the user overlay video over different images that are derived from slides of the set of slides at timestamps that are denoted in the set of presentation metadata, the device generates video frames of this overlay at a given framerate. The video frames are generated in a manner that is hidden from being displayed at a display screen of the device so that the user of the device is not also shown a playback of the video presentation.

As described in FIG. 1, various embodiments described herein allow a recording of a video presentation of slides to be independently stored as separate underlying assets associated with a composite media. As a result, the underlying assets can be independently edited (mutated) after the recording has completed, by the same user that had made the original recording or by a different user. Edits to the underlying assets can be made for a number of different use cases such as, for example, to customize the slides to address a different audience, make corrections to the recorded user overlay video or slides, change the manner in which the slides are presented with the user overlay video, and/or provide a quick set of starting point slides for a new user instead of requiring the new user to reproduce the slides from scratch. An updated video presentation comprising either real-time render/playback or an exported video file can then be derived from the composite media based on its associated edited/mutated underlying assets to achieve a different (e.g., refined/updated) video presentation than the one that was recorded but without requiring the creator user to rerecord the presentation.

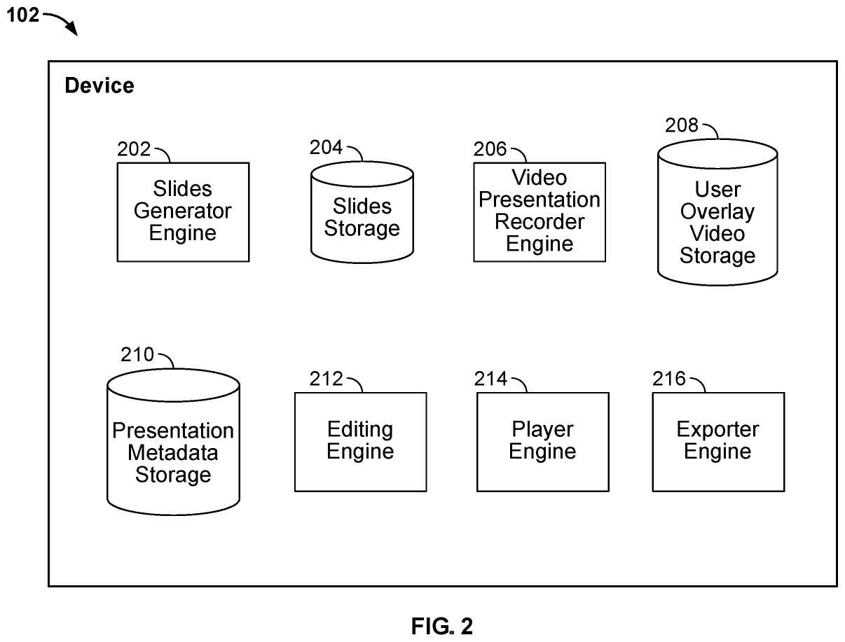

FIG. 2 is a diagram showing an example of a device. In some embodiments, device 102 (or any other device) of system 100 of FIG. 1 may be implemented using the example of FIG. 2. The example device of FIG. 2 includes slides generator engine 202, slides storage 204, video presentation recorder engine 206, user overlay video storage 208, presentation metadata storage 210, editing engine 212, player engine 214, and exporter engine 216. Each of slides storage 204, user overlay video storage 208, and presentation metadata storage 210 may be implemented using any appropriate storage medium. Each of slides generator engine 202, slides storage 204, video presentation recorder engine 206, user overlay video storage 208, presentation metadata storage 210, editing engine 212, player engine 214, and exporter engine 216 may be implemented using hardware and/or software.

Slides generator engine 202 is configured to provide a user interface to enable a user to generate a set of slides. In some embodiments, slides generator engine 202 is configured to provide one or more templates at the user interface for the user to choose from. For example, a template specifies a background color, a font type, a font color, font sizes, and/or the locations of elements on each slide. In some embodiments, slides generator engine 202 is configured to provide tools for the user to generate slides without a template. For example, the user interface-based tools that are provided by slides generator engine 202 may include the functionalities to generate new slides to a set of slides, add new elements (e.g., titles, text, bullet points, images, videos) to each slide, change the background color for the entire set of slides, and change the font for the entire set of slides. As mentioned above, in various embodiments, each slide in a set of slides is stored as an object with at least a slide-specific identifier. Also, as mentioned above, in various embodiments, each element on a slide is stored as a separate object and with at least an element-specific identifier and an identifier of a slide with which it is associated. In some embodiments, each set of slides includes global variables such as, for example, background color and font such that if the background color or font is updated for the set of slides, then the background color or font of each slide in the set is updated accordingly. Due to each slide being represented by a respective object and elements of each slide being represented by respective objects, each set of slides is stored at slides storage 204 as a collection of slide objects, element objects, and/or other variables/objects belonging to the set.

Slides storage 204 is configured to store sets of slides that are generated at the device (e.g., using slides generator engine 202) or obtained from a different device or server (e.g., mutable composite media server 112 of FIG. 1). As mentioned above, a set of slides that is generated/authored by one user at one device can be requested and downloaded to a second device that is used by another user for the second user to edit and/or include in a recording of a video presentation.

Video presentation recorder engine 206 is configured to provide a user interface at which a user can select a set of slides to use during a video presentation recording. In response to a selection of a set of slides (e.g., that was previously generated and stored at slides storage 204), video presentation recorder engine 206 is configured to activate sensors such as a camera and a microphone of the device to record a user video stream, and also a set of presentation metadata related to the user's actions with respect to recording and when and how the user had presented/interacted with the slides. In some embodiments, during the recording of the video presentation comprising the user video stream and the corresponding set of presentation metadata, video presentation recorder engine 206 is configured to present a user interface that shows at least a portion of the current user feed that is captured by the camera within a window of predetermined dimensions in a designated location over the current slide that was selected by the user to be presented. As mentioned above, the user video stream that is recording during a video presentation associated with a set of slides is referred to as the “user overlay video” underlying asset associated with a composite media related to that video presentation recording. The user overlay video associated with the composite media is stored at user overlay video storage 208 along with an identifier associated with that composite media. As mentioned above, the set of presentation metadata associated with the composite media comprises timestamps within the recording (e.g., the timeline of the user overlay video) at which various slides of the set were presented. Furthermore, the presentation metadata associated with the composite media comprises recorded user actions and timestamps within the recording (e.g., the timeline of the user overlay video) at which those user actions occurred during the recording. A recorded user action may include an action that is related to a specified slide or one or more specified elements on a specified slide. A recorded user action includes an action that adjusts the user overlay video or is otherwise independent of the slides. The set of presentation metadata associated with the composite media is stored at presentation metadata storage 210 along with an identifier associated with that composite media.

Editing engine 212 is configured to provide a user interface for a user to edit underlying assets associated with composite media. In some embodiments, editing engine 212 is configured to provide a user interface that presents identifying information associated with composite media for which underlying assets can be edited. In some embodiments, editing engine 212 can present identifying information associated with composite media for which underlying assets are stored locally (e.g., at slides storage 204, user overlay video storage 208 and/or presentation metadata storage 210) or stored remotely (e.g., by a mutable composite server such as mutable composite server 112 of FIG. 1). In response to a request for a composite media for which underlying assets are stored locally, editing engine 212 is configured to retrieve those assets from the local storage(s). In response to a request for a composite media for which underlying assets are stored remotely, editing engine 212 is configured to request those assets from the remote storage (e.g., mutable composite media server 112). In some embodiments, in response to a request from a user to edit any underlying assets associated with a composite media, editing engine 212 is configured to provide the user an option to create a new composite media (e.g., with a new composite media identifier) with a copy of at least a portion of the requested underlying assets or to edit the existing composite media (e.g., with the existing composite media identifier) by editing the requested underlying assets.

After retrieving the underlying assets for a user selected composite media, editing engine 212 is configured to enable the user to edit any one of the underlying assets including, for example, the set of slides, the user overlay video, and the set of presentation metadata. For example, the user can edit the set of slides by changing the elements (e.g., text, image, bullet points, title) on the slides, changing the background color, changing the font, adding new slide(s), or removing existing slide(s). For example, the user can edit the user overlay video by removing segments of the video (e.g., segments associated with undesirable user speech or other disfluencies) or by adding new segments to the video (e.g., by appending a second video to the original video). For example, the user can edit the set of presentation metadata by changing the timestamps within the user overlay video of when slides are presented (in a manner that is overlaid by the user overlay video) and changing the recorded user action (e.g., that may or may not interact with a specific slide or specific element of a slide) associated with a timestamp within the user overlay video. In some embodiments, editing engine 212 is configured to store the set of slides, the user overlay video, and the set of presentation metadata and edit(s), if any, to each underlying asset, associated with the selected composite media. In some embodiments, for each underlying asset associated with a selected composite media that is edited, editing engine 212 stores a new copy with the edits or a reference from the original copy of the underlying assets to the edits so as to preserve the version of the underlying asset prior to the editing.

Player engine 214 is configured to render a composite media for a playback of a presentation of a set of slides at a display screen (not shown in FIG. 2) of the device. For example, after a user had made edits to one or more of the underlying assets (the set of slides, the user overlay video, and the set of presentation metadata) associated with a composite media, the user can request to view a presentation that is rendered from the edited underlying assets of the composite media. In response to the request to render the composite media, player engine 214 is configured to first retrieve the latest (edited) versions, if any, of the underlying assets of that composite media. As will be described in further detail below, player engine 214 is configured to render the composite media by cropping the user overlay video according to predetermined dimensions/shape (e.g., associated with the display screen of the device) and presenting the cropped user overlay video in a manner that overlays images of the slides. Each image of a slide is generated based on a slide that is specified as having been presented in the set of presentation metadata and that image is presented under the user overlay video at a timestamp that is indicated in the set of presentation metadata. Furthermore, the slide in an image may also be manipulated to correspond to a recorded user action (e.g., a highlighting of a slide element) with respect to that image, if appropriate. Player engine 214 is configured to output the alignment of the user overlay video over the images derived from the slides at a display screen of the device in a way that allows the recorded (and potentially edited) user overlay video to be played over the slides (that were potentially edited after the initial recording of the user overlay video) for the user to review the effect of the post video presentation recording mutation of the underlying assets.

Exporter engine 216 is configured to generate a video file comprising a rendered presentation of a composite media. For example, after a user had made edits to one or more of the underlying assets (the set of slides, the user overlay video, and the set of presentation metadata) associated with a composite media, the user can request to share/export a video file comprising a presentation that is rendered from the edited underlying assets of the composite media. In response to the request to share/export a video file generated from the composite media, exporter engine 216 is configured to first retrieve the latest edited versions, if any, of the underlying assets of that composite media. As will be described in further detail below, exporter engine 216 is configured to render a presentation by generating video frames (e.g., at a given frame rate) comprising an overlay of a cropped version of the user overlay video over a time-aligned video that is generated based on the set of slides and the set of presentation metadata. Unlike the presentation that is output by player engine 214 to the display screen of the device, the generation of the video file (comprising the generation of the series of video frames) is hidden in the background and not presented at the display screen of the device. Also, unlike the presentation that is output by player engine 214, the video file (e.g., a MP4) is a file that can be stored at the device and/or sent to another device or a remote server (e.g., the mutable composite media server or a server associated with a social media platform).

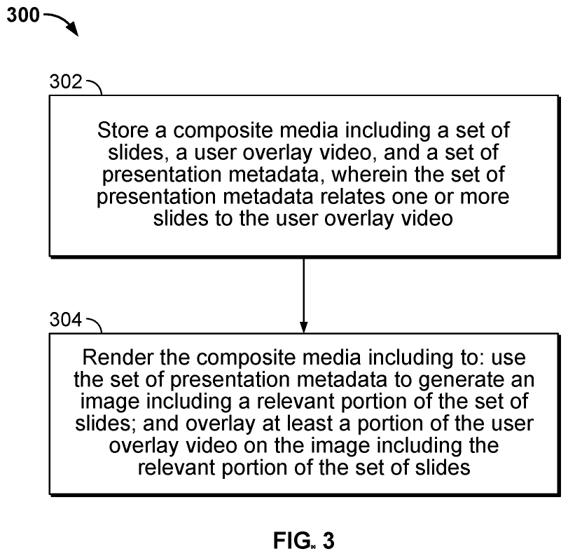

FIG. 3 is a flow diagram showing an embodiment of a process for rendering a mutable composite media. In some embodiments, process 300 may be implemented at a device such as any of devices 102, 104, or 106 of FIG. 1.

At 302, a composite media including a set of slides, a user overlay video, and a set of presentation metadata is stored, wherein the set of presentation metadata relates one or more slides to the user overlay video. A recording of a video presentation comprising a user video feed with concurrent presentations of slides from a (previously generated) set of slides (e.g., a file) is made at a device. As a result of the recording, a composite media comprising the underlying assets of a set of slides (or a reference to the set of slides), the user video feed (which is sometimes referred to as the “user overlay video”), and a set of presentation metadata is stored. In various embodiments, the set of presentation metadata comprises timestamps in the user overlay video at which different slides were presented. In various embodiments, the set of presentation metadata comprises timestamps in the user overlay video at which user actions were performed with respect to or independent from the set of slides. In various embodiments, after the composite media is stored, any one or more of its underlying assets can be edited/mutated by a user (e.g., either the same user that had generated the user overlay video or a different user).

At 304, the composite media is rendered including to: use the set of presentation metadata to generate an image including a relevant portion of the set of slides; and overlay at least a portion of the user overlay video on the image including the relevant portion of the set of slides. In response to a request to render/play or export the composite media, the user overlay video is cropped in accordance with attributes (e.g., screen size, device type) of the device at which the playback is to occur and/or the device to which an exported video file is to be sent. Also, images are generated from the slides based on the set of presentation metadata. For example, an image of the slide can be an image file (e.g., a PNG file) version of an unmodified slide or an image file version of a slide that has been modified based on a recorded user action as included in the set of presentation metadata. In the event that the request is to play the composite media at the display screen, then the user overlay video is aligned over the slide-based images at corresponding timestamps as indicated in the set of presentation metadata and the aligned media is directly output to the display screen of the device. In contrast, in the event that the request is to export the composite media screen, then video frames (e.g., at a given framerate) are generated based on the time-aligned overlay of the user overlay video over a video derived from the slide-based images in a way that is hidden from the display screen of the device.

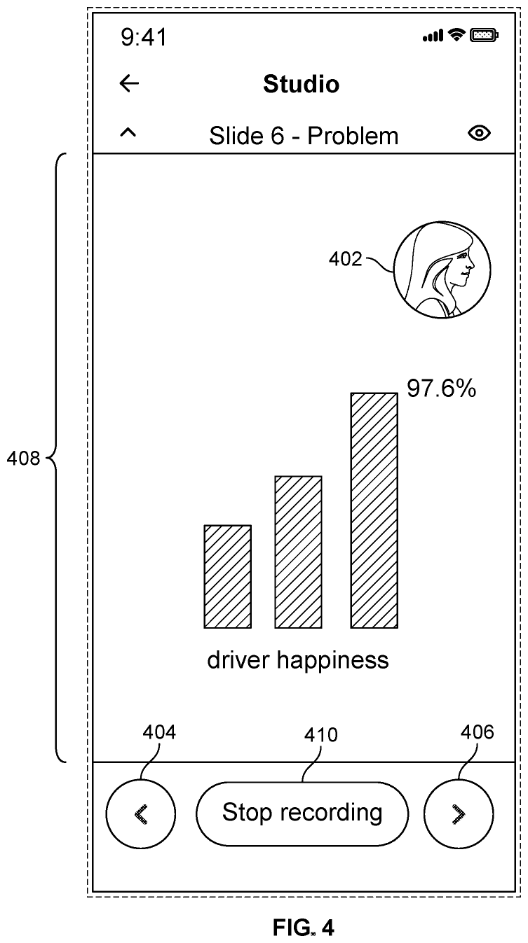

FIG. 4 is a diagram showing an example of a user interface that is presented at a display screen of a device while a user is recording a video presentation of a set of slides. Prior to the start of making the recording, the user had selected a previously generated set of slides to present in the video. The user feed that is being recorded by a (e.g., front-facing) camera on the device is shown in circle 402, which is shown to be overlaid slide 408, the current slide of the selected set of slides that the user has selected to present at this point in the presentation. For example, while slide 408 is being presented in a manner that is overlaid by the user video feed in circle 402, the user's recorded speech describes what is shown in slide 408. Also, for example, while slide 408 is being presented, the user could also perform one or more user actions. A first example user action is to interact with slide 408 such as to select a portion (e.g., highlight the text “driver happiness”) of the slide and/or to zoom in on a portion of the slide. Such a user action would be stored as part of the set of presentation metadata that is associated with the composite media associated with this recording and would include information such as the timestamp in the recording/user feed video at which the action occurred, an identifier of the element on slide 408 that was affected by the user action, and also the type of action. A second example user action is an action that is independent of slide 408 and can include a modification to the recording such as the addition of a filter over the user feed video. Such a user action would be stored as part of the set of presentation metadata that is associated with the composite media associated with this recording and would include information such as the timestamp in the recording/user feed video at which the action occurred and also the type of action. To transition to the presentation of a different slide in the set of slides during the recording, the user can select previous button 404 to transition to the previous slide in the set or select next button 406 to transition to the next slide in the set. The timestamp at which the previous or next slide relative to slide 408 was selected to be presented during the recording/user feed video is also recorded as part of the set of presentation metadata. When the user has completed recording his or her video presentation, then the user can select stop recording button 410 to end the recording. After the recording is ended, a composite media corresponding to the recording and comprising the underlying assets of the set of slides (or a reference to the set of slides) used in the presentation, the user overlay video, and the set of presentation metadata is stored. As described in various embodiments herein, any of such underlying assets can then be edited before the composite media is rendered for a playback at the local device or exported as a video file to be shared with another device or remote server.

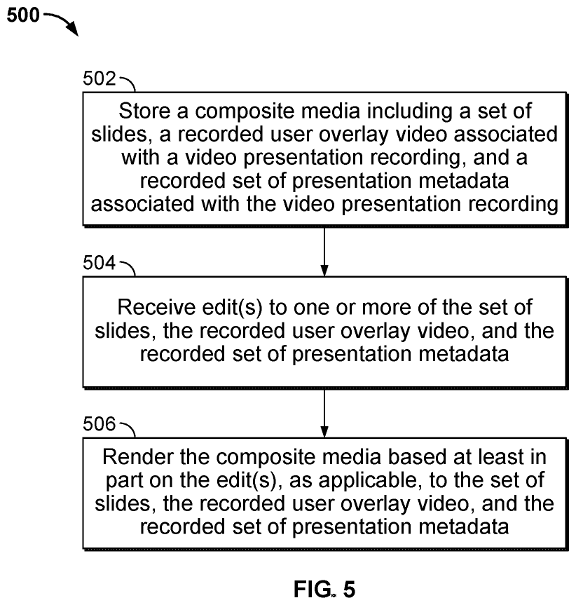

FIG. 5 is a flow diagram showing an example of a process for rendering a mutable composite media. In some embodiments, process 500 may be implemented at a device such as any of devices 102, 104, or 106 of FIG. 1. In some embodiments, process 300 of FIG. 3 may be implemented, at least in part, using process 500.

At 502, a composite media including a set of slides, a recorded user overlay video associated with a video presentation recording, and a recorded set of presentation metadata associated with the video presentation recording is stored. For a user's recording of a video presentation of a set of slides, a corresponding composite media comprising at least the following underlying assets is stored: a reference to or a copy of the set of slides, the user overlay video (of the user's speech, facial expressions, and/or gesticulation during the presentation), and a set of presentation metadata that describes which slide is shown at which timestamps and which user actions are performed at which timestamps during the timeline associated with the user overlay video. Each of the underlying assets can relate to the same composite media but is separately stored.

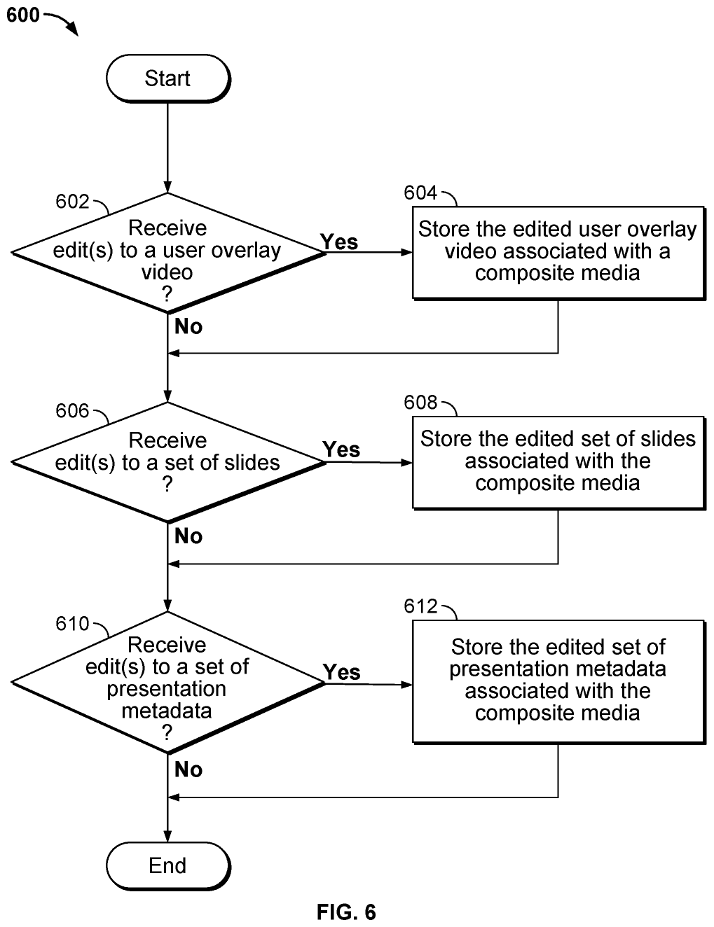

At 504, edit(s) to one or more of the set of slides, the recorded user overlay video, and the recorded set of presentation metadata are received. Each of the underlying assets can relate to the same composite media but is separately stored. As such, each of the underlying assets can also be separately edited by a user before being rendered with the other underlying assets related to the same composite media. Example reasons for editing any of the underlying assets associated with the composite media may be to fix an error in the slides that are shown in a video presentation, change the appearance of the slides that are shown in the video presentation, refine the speech/appearance/length of a recorded user video in a video presentation, and/or alter the manner in which slides are presented within a video presentation. FIG. 6, as will be described below, describes an example process for editing underlying assets of a composite media.

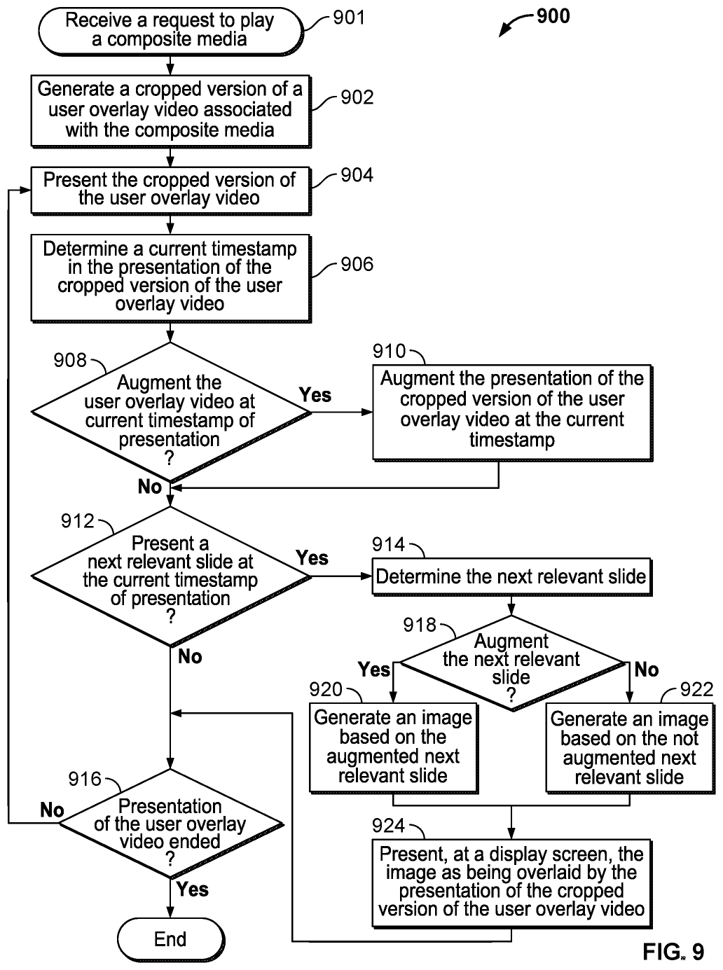

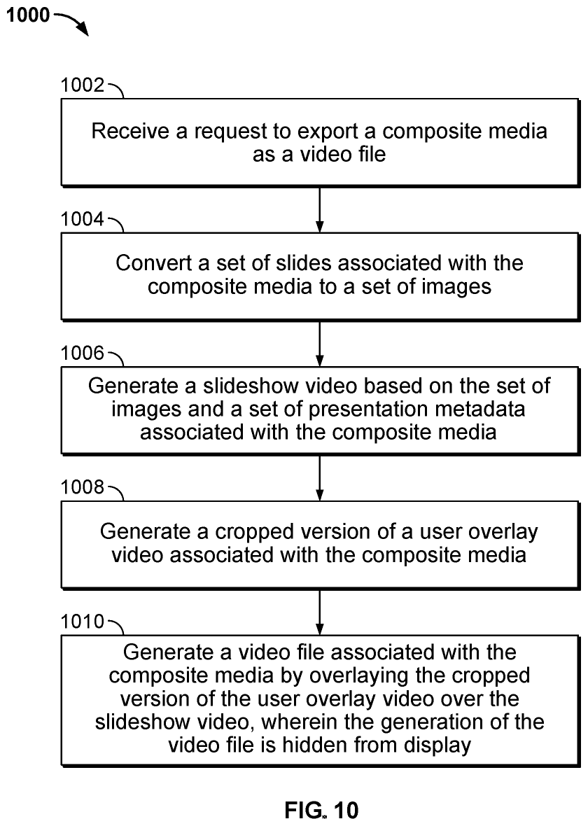

At 506, the composite media is rendered based at least in part on the edit(s), as applicable, to the set of slides, the recorded user overlay video, and the recorded set of presentation metadata. In response to a user request to play a video presentation or export a video file of a video presentation associated with the composite video, the latest version of the underlying assets, some or all of which may have been edited since the initial recording associated with the composite video, are obtained from storage. Then, along with zero or more other parameters (e.g., a device type or display screen dimensions of the device at which the video presentation is to be played/presented and/or at which the video file is to be sent), a video presentation is rendered based on the obtained underlying assets of the (potentially edited) set of slides, the (potentially edited) user overlay video, and the (potentially edited) set of presentation metadata. FIG. 9, as will be described below, describes an example process for playing a video presentation based on a composite media. FIG. 10, as will be described below, describes an example process for exporting a video file comprising a video presentation based on a composite media.

FIG. 6 is a flow diagram showing an example of a process for receiving edits to underlying assets associated with a composite media. In some embodiments, process 600 may be implemented at a device such as any of devices 102, 104, or 106 of FIG. 1. In some embodiments, step 504 of process 500 of FIG. 5 may be implemented, at least in part, using process 600.

Process 600 is an example process for receiving edits to underlying assets associated with a composite media that shows that edits can be independently made to zero or more of the assets of a composite media (e.g., after the initial recording of the video presentation associated with the composite media and before the composite media is rendered into a video presentation).

At 602, whether edit(s) to a user overlay video associated with a composite media are received is determined. In the event that edit(s) to the user overlay video are received, control is transferred to 604. Otherwise, in the event that edit(s) to the user overlay video are not received, control is transferred to 606. For example, the user overlay video can be edited by a user or edited programmatically to remove segments of undesirable user speech. The user overlay video can also be edited by having new segments inserted into the original video.

At 604, the edited user overlay video associated with the composite media is stored.

At 606, whether edit(s) to a set of slides associated with the composite media are received is determined. In the event that edit(s) to the set of slides are received, control is transferred to 608. Otherwise, in the event that edit(s) to the set of slides are not received, control is transferred to 610. For example, the set of slides can be edited by a user to change the elements/content on one or more slides, to change the background color, and/or to change the font across the slides.

At 608, the edited set of slides associated with the composite media is stored. In some embodiments, prior to storing the set of slides, the edits are compared/validated against rules to determine whether they are permitted to be stored. For example, rules associated with edits to the set of slides may prohibit the deletion of element(s) that are referenced by/associated with specific user actions that are stored in the set of presentation metadata.

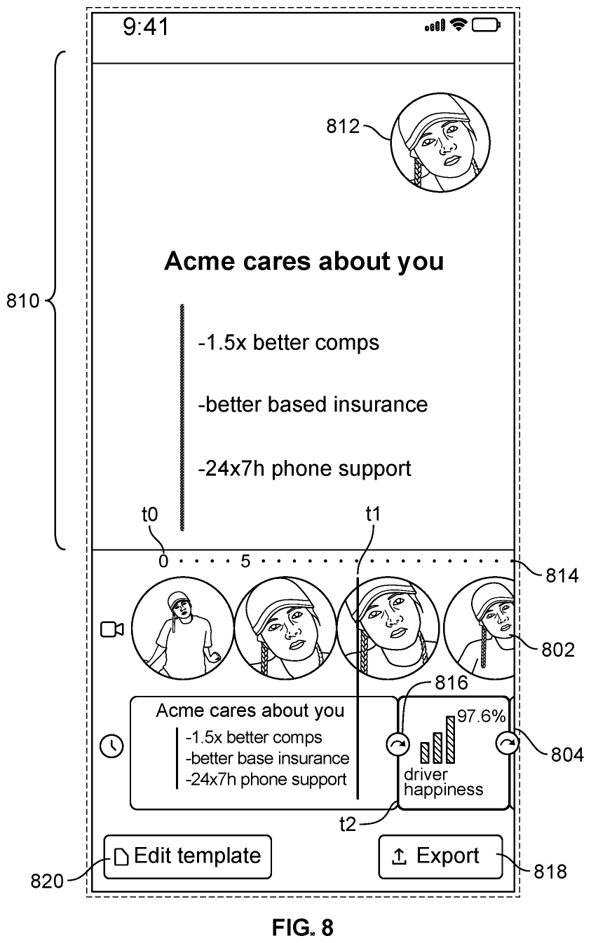

At 610, whether edit(s) to a set of presentation metadata associated with the composite media are received is determined. In the event that edit(s) to the set of presentation metadata are received, control is transferred to 612. Otherwise, in the event that edit(s) to the set of presentation metadata are not received, process 600 ends. For example, the set of presentation metadata can be edited by a user to change the time alignment between when slides of the set of slides are presented relative to the user overlay video and/or to change the time alignment or the underlying actions of recorded user actions (performed with respect to or independent of the set of slides). In some embodiments, the set of presentation metadata records the timestamp in the timeline of user overlay video at which each slide is presented. As such, to change the time alignment between the presentation of slides, the timestamps associated with when slides appear with the overlay video can be modified. Similarly, to change the time alignment between the occurrence of user actions and the overlay video, the timestamps associated with the timestamps of recorded user actions with the overlay video can be modified. In some embodiments, the time alignment between timestamps of slide appearance/user action occurrences and the user overlay video can be edited at a user interface, such as shown in FIG. 8, as will be described below.

At 612, the edited set of presentation metadata associated with the composite media is stored.

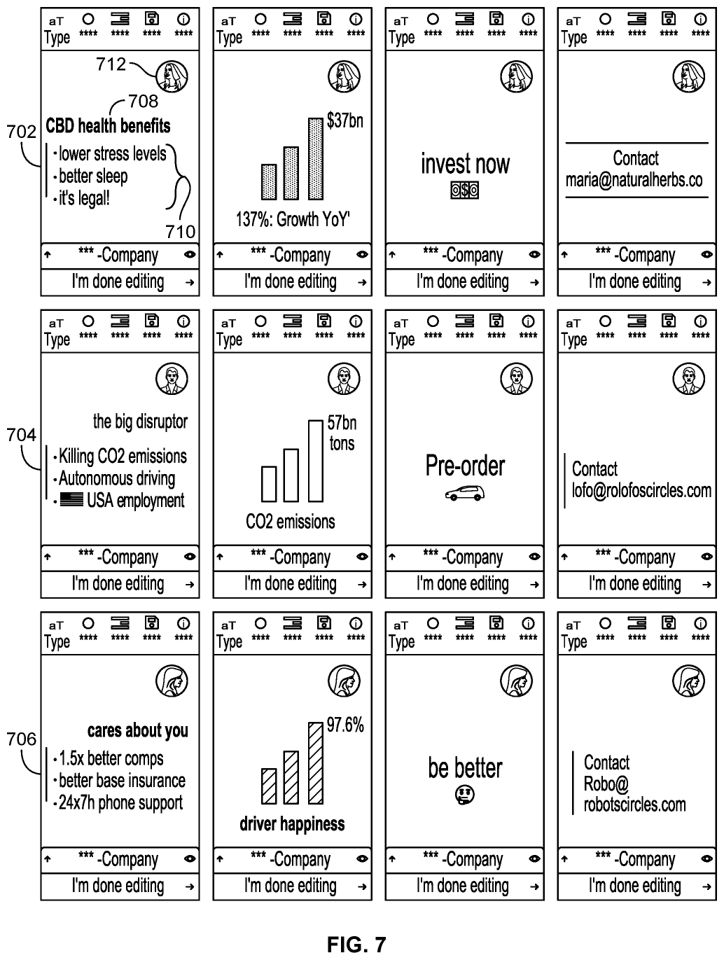

FIG. 7 is a diagram showing three examples of sets of slides as they are being edited at a user interface. Each of sets of user interfaces 702, 704, and 706 is associated with a respective set of slides that are editable. As mentioned above, a set slides can be created before it is included in a recording of a video presentation and a set of slides that was used in a recording of a video presentation (and becomes an underlying asset associated with the composite media corresponding to the recording). The example user interfaces for editing a set of slides as shown in FIG. 7 can be used to edit a set of slides before and after it is associated with a composite media because as described in various embodiments, a set of slides that becomes an underlying asset for a composite media is still mutable prior to being rendered with the composite media in a video presentation. Set of user interfaces 702 shows four different user interfaces (e.g., that can be displayed at a device) that are used to successively edit different slides of the same set of files. Set of user interfaces 704 and set of user interfaces 706 each similarly shows four different user interfaces (e.g., that can be displayed at a device) that are used to successively edit different slides of respective sets of files. In the example sets of slides of FIG. 7, the slides of each set share a common template (e.g., the template comprises a specified background color and font characteristics). In some embodiments, where a set of slides shares a template, a change to a template-related attribute, such as a font characteristic or the background color, on one slide in a set will automatically be propagated to the other slides (and correspondingly show in the user interface to edit the slides). For example, the sets of slides can be edited to change a background color, the font, add or remove slides, and/or change the elements/content that is shown on each slide.

In various embodiments, each element on each slide is stored as a separate object associated with the slide object and/or the set of slides. For example, in the slide that is shown in the first/leftmost user interface of set of user interfaces 702, the slide includes a placeholder/location of cropped user overlay video 712 and elements 708 and 710. Element 708 is a title structure and element 710 is a bullet structure and they can be respectively stored as two separate objects. As such, if during a video presentation involving the set of slides associated with set of user interfaces 702, a user performs a user action (e.g., highlighting or zooming) with respect to one of element 708 and 710, then the corresponding recorded user action would identify the identifier of the affected element and the timestamp at which the user action was performed during the recording/timeline associated with the user overlay video.

FIG. 8 is a diagram showing an example of a user interface for editing the time alignment between a user overlay video and the presentation of a set of slides associated with a composite media. As described herein, after a composite media comprising at least a user overlay video, a set of slides, and a set of presentation metadata is stored, the time alignment between the user overlay video and the set of slides as described by the set of presentation metadata can be edited. FIG. 8 shows an example user interface for editing the time alignment between the user overlay video and the set of slides as described by the set of presentation metadata. Timeline 814 shows a timeline of the user overlay video associated with the composite media. User overlay video preview 802 shows select video frames from the user overlay video at each given interval of time (e.g., at every five seconds) along timeline 814. Presentation of slides preview 804 shows which slide (of the set of slides that is associated with the composite media) was indicated by the set of presentation metadata to be presented at a given segment along timeline 814. Overlaid preview 810 shows the rendering of (e.g., a cropped version of) the current video frame of the user overlay video 812 at a current preview time (which is currently at time t1) on timeline 814 overlaying the slide that is indicated to be presented at that time. To change the time alignment between the user overlay video and the presentation of the slides (and therefore edit/update the set of presentation metadata associated with the composite media), the user can select a transition button (such as transition button 816) and drag it in either direction along timeline 814 to lengthen or shorten the time segment during which the slides adjacent to that transition button will be presented. For example, the presentation of the slide with the title “Acme cares about you” is shown to transition to the next slide containing a histogram at time t2 of timeline 814. However, the user can change that transition to occur earlier along timeline 814 by selecting transition button 816 and moving it leftwards or conversely, the user can change that transition to occur later along timeline 814 by selecting transition button 816 and moving it rightwards.

To edit the set of slides associated with the composite media, the user can select “Edit Template” button 816. Assuming that the set of slides is updated prior to returning to the user interface of FIG. 8, then the presentation of slides preview 804 would be updated to show the updated set of slides. To export a video file based on the (edited) composite media, the user can select “Export” button 818.

While not shown in FIG. 8, beyond time alignment between the user overlay video and the presentation of slides, the set of presentation metadata can also be edited to change the timestamps at which recorded user actions with respect to elements of presented slides occur and/or the type of actions that are performed at recorded timestamps.

FIG. 9 is a flow diagram showing an example process for rendering a composite media to play a video presentation at a display screen of a device. In some embodiments, process 900 may be implemented at a device such as any of devices 102, 104, or 106 of FIG. 1. In some embodiments, step 304 of process 300 of FIG. 3 may be implemented, at least in part, using process 900.

At 901, a request to play a composite media is received. A request to locally play a video presentation that is generated from the composite media at the device is received. For example, after a user has edited one or more of the underlying assets of the composite media, the user may request to view a rendered presentation of the composite media to check whether they want to perform any further edits or if they are satisfied with the resulting presentation.

At 902, a cropped version of a user overlay video associated with the composite media is generated. In some embodiments, video frames of the user overlay video are of a given dimension but the user overlay video may need to be cropped prior to being presented over image(s) of slides associated with the composite media so that the user overlay video will play within a predetermined shape or sized frame and also in a manner that does not obscure the content on the slides that the user overlay video will be presented on top of. For example, the location of the user's face is identified within each video frame of the user overlay video using a machine learning model that is trained to recognize the location of a face and then each video frame is cropped to center on the respective face. For example, a cropped video frame of the user overlay video is a circle shape and the radius of the circle can be dynamically determined based on factors such as, for example, the type of the device at which the presentation will be played.

At 904, the cropped version of the user overlay video is presented. The cropped version of the user overlay video is played in a video player at a first layer at a display screen of the device.

At 906, a current timestamp in the presentation of the cropped version of the user overlay video is determined. In various embodiments, the current timestamp of the presentation/playback of the user overlay video is determined (e.g., at a given interval since the last determination) and used to determine which slide is to be concurrently presented and/or which user action is to be concurrently performed in accordance with the set of presentation metadata associated with the composite media.

At 908, whether the user overlay video is to be augmented at the current timestamp of the presentation is determined. In the event that the user overlay video is to be augmented at the current timestamp of the presentation, control is transferred to 910. Otherwise, in the event that the user overlay video is not to be augmented at the current timestamp of the presentation, control is transferred to 912. The user overlay video could be augmented at the current timestamp if a recorded user action in the set of presentation metadata indicates that a user action related to augmenting the appearance of the user overlay video occurred at the current timestamp. Examples of recorded user actions that occurred with respect to the user overlay video include the addition of a video filter, the addition of background music, and the changing of the volume of the background music.

At 910, the presentation of the cropped version of the user overlay video is augmented at the current timestamp. The user overlay video is modified at the current timestamp in accordance with the relevant recorded user action.

At 912, whether a next relevant slide is to be presented at the current timestamp of the presentation is determined. In the event that a next relevant slide is to be presented at the current timestamp of the presentation, control is transferred to 914. Otherwise, in the event that a next relevant slide is not to be presented at the current timestamp of the presentation, control is transferred to 916. In some embodiments, the set of presentation metadata indicates the timestamp at which each slide of a set of slides associated with the composite media starts to be presented during a video presentation. If the set of presentation metadata indicates that a new slide of the set of slides (relative to the current slide that is being presented, if any) has started to be presented at the current timestamp, then this new slide is determined to be presented in a way that is overlaid by the cropped user overlay video.

At 914, the next relevant slide is determined. For example, the set of presentation metadata can indicate the slide identifier of a slide that is to be presented at/near the current timestamp of the user overlay video. As such, the slide can be obtained based on its slide identifier.

At 918, whether the next relevant slide is to be augmented is determined. In the event that the next relevant slide is to be augmented, control is transferred to 920. Otherwise, in the event that the next relevant slide is not to be augmented, control is transferred to 922. The relevant slide could be augmented at the current timestamp if a recorded user action in the set of presentation metadata indicates that a user action related to augmenting the original appearance of the slide occurred at the current timestamp. Examples of recorded user actions that occurred with respect to a slide include the highlighting of an element (e.g., an image, a title, or a bullet string) of the slide and the zooming in on an element of the slide.

At 920, an image is generated based on the augmented next relevant slide. Where a recorded user action at or near the current timestamp of the presentation of the user overlay video indicated a user action that changed the appearance of the slide, then an image (e.g., a PNG image) is generated based on that augmented appearance of the slide. For example, if the user action highlighted a title element on that slide, then the generated/rendered image would show the slide with highlighting of the title element. For example, generating an image from the slide includes to paint the objects of the slide as device pixels.

At 922, an image is generated based on the not augmented next relevant slide. Where there is no recorded user action at or near the current timestamp of the presentation of the user overlay video that indicated a user action that changed the appearance of the slide, then an image (e.g., an PNG) is generated based on the stored version of the slide. For example, the generated/rendered image would show the slide without any modifications.

At 924, the image is presented as being overlaid by the presentation of the cropped version of the user overlay video at a display screen. Regardless if the image was generated/rendered at step 920 or 922, the image is presented in a second layer at the display screen of the device and in a manner that is overlaid by the first layer comprising the cropped version of the user overlay video. In particular, the cropped version of the user overlay video is presented over a designated offset/location over the image of the slide.

At 916, whether the presentation of the user overlay video has ended is determined. In the event that the presentation of the user overlay video has ended, process 900 ends. Otherwise, in the event that the presentation of the user overlay video has not ended, control is returned to step 904 (e.g., after a given interval of time). Until the current timestamp of the presentation of the user overlay video is near or meets the end timestamp of the user overlay video, steps 906 through 924 are to be performed to allow a video player comprising the cropped user overlay video to be presented over images of slides at a time alignment that is dictated by the set of presentation metadata and where the (e.g., appearance of) user overlay video and/or the slides are also augmented, at appropriate timestamps, by the set of presentation metadata.

FIG. 10 is a flow diagram showing an example process for exporting a composite media to generate a video presentation in a manner that is hidden from a display screen of a device. In some embodiments, process 1000 may be implemented at a device such as any of devices 102, 104, or 106 of FIG. 1. In some embodiments, step 304 of process 300 of FIG. 3 may be implemented, at least in part, using process 1000.

Unlike playing a presentation associated with the composite media at a display screen of a device, exporting a video file of the composite media and as described by process 1000 is performed in the background and in a manner that is hidden from being displayed to the user.

At 1002, a request to export a composite media as a video file is received. A request to generate a video file of a presentation from the composite media at the device is received. For example, after a user has viewed a rendered presentation of the composite media, the user decides to export the presentation as a video file that the user can share with another device and/or with the mutable composite media server.

At 1004, a set of slides associated with the composite media is converted to a set of images. The slides of the set of slides associated with the composite media that appear within the presentation according to the set of presentation metadata are determined and converted into a set of images. For example, generating an image from a slide includes painting the objects of the slide as device pixels.

At 1006, a slideshow video is generated based on the set of images and a set of presentation metadata associated with the composite media. The set of images are concatenated into a slideshow video in accordance with the set of presentation metadata. Specifically, segments of the slideshow video during which each slide appears are determined based on the timestamps at which slides start to be presented in the user overlay video as tracked in the set of presentation metadata.

At 1008, a cropped version of a user overlay video associated with the composite media is generated. In some embodiments, video frames of the user overlay video are of a given dimension but the user overlay video may need to be cropped prior to being presented over image(s) of slides associated with the composite media so that the user overlay video will play within a given shape or sized frame and also in a manner that does not (significantly) obscure the content on the slides that the user overlay video will be presented on top of. The cropped version of the user overlay video is played in a video player at a first layer at a display screen of the device.

At 1010, a video file associated with the composite media is generated by overlaying the cropped version of the user overlay video over the slideshow video, wherein the generation of the video file is hidden from display. The cropped version of the user overlay video (the first layer) is overlaid over the slideshow video, which is presented at a second layer, at a designated offset over the slideshow video. Then, video frames (e.g., at a given frame rate) are generated from this combination of user overlay video on top of the slideshow video to generate a video file that shows a video presentation that was derived from the underlying assets of the composite media. The generation of the video file is performed in the background and where the overlaid video frames are not directly output to the display screen as they are made by calling a library (e.g., FFmpeg), which controls the device, camera, and recorder. After the video file is ready, a prompt can be presented at the user interface of the device to inform the user that the video file is now ready to be viewed in a video player application and/or shared with another device or the mutable composite media server.

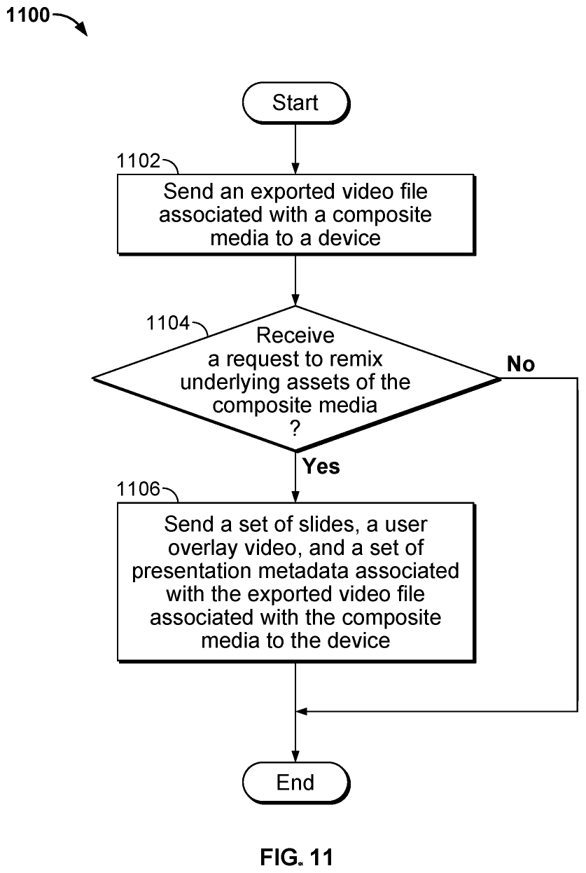

FIG. 11 is a flow diagram showing an example process for efficiently sharing a composite media. In some embodiments, process 1100 may be implemented at a mutable composite media server of FIG. 1. In some embodiments, step 304 of process 300 of FIG. 3 may be implemented, at least in part, using process 1100.

Process 1100 describes an example of a process in which a mutable composite media server, which has received uploads of an exported video file generated from a composite asset and also the underlying assets of that composite media, is configured to selectively share the underlying assets of that composite media with a requesting device.

At 1102, an exported video file associated with a composite media is sent to a device. A user at a device can request a video file that has been exported from a composite media (e.g., where that video file was generated using a process such as process 1000 of FIG. 10 at an originating device before the device had uploaded it to the server).

At 1104, whether a request to remix underlying assets of the composite media is received is determined. In the event that a request to remix underlying assets of the composite media is received, control is transferred to 1106. Otherwise, in the event that a request to remix underlying assets of the composite media is not received, process 1100 ends. As mentioned above, because the underlying assets of a composite media are separately stored, a user that did not author any of the underlying assets can request at least some of the underlying assets to edit and to potentially make a new video presentation using the requested set of slides (or an edited version thereof), make a new video presentation using the requested user overlay video (or an edited version thereof) with a different set of slides, and so forth. The idea of allowing new users to remix underlying assets of existing composite media can foster quicker spreading and customization of videos with lowered friction. Because the underlying assets of a composite media are large files, in some embodiments, the mutable composite media server does not send the underlying assets of a composite media to a device unless the user of that device specifically makes a request (e.g., at a user interface) for the underlying assets.

At 1106, a set of slides, a user overlay video, and a set of presentation metadata associated with the exported video file associated with the composite media are sent to the device.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
store a composite media including a set of slides, a user overlay video, and a set of presentation metadata, wherein the set of presentation metadata relates one or more slides to the user overlay video; and
render the composite media including to:
use the set of presentation metadata to generate an image including a relevant portion of the set of slides; and
overlay at least a portion of the user overlay video on the image including
the relevant portion of the set of slides; and
a memory coupled to the processor and configured to provide the processor with instructions.

2. The system of claim 1, wherein the processor is further configured to record the set of presentation metadata and the user overlay video corresponding to a video presentation that is recorded at the system.

3. The system of claim 1, wherein the processor is further configured to receive an edit to the user overlay video, wherein the edit is to remove a segment from the user overlay video, and wherein the rendering of the composite media is based at least in part on the edited user overlay video.

4. The system of claim 1, wherein the processor is further configured to receive an edit to the set of slides, wherein the edit is to change an element of a slide of the set of slides, and wherein the rendering of the composite media is based at least in part on the edited set of slides.

5. The system of claim 1, wherein the processor is further configured to receive an edit to the set of presentation metadata, wherein the edit is to change a timestamp at which a slide of the set of slides is to be presented relative to the user overlay video, and wherein the rendering of the composite media is based at least in part on the edited set of presentation metadata.

6. The system of claim 5, wherein the processor is further configured to provide a user interface for receiving an adjustment of a time alignment between a presentation of the set of slides and the user overlay video.

7. The system of claim 1, wherein the processor is further configured to receive an edit to the set of presentation metadata, wherein the edit is to change a recorded user action associated with a presentation of the set of slides, and wherein the rendering of the composite media is based at least in part on the edited set of presentation metadata.

8. The system of claim 1, wherein to use the set of presentation metadata to generate the image including the relevant portion of the set of slides includes to:
augment a slide of the set of slides based at least in part on a recorded user action that is included in the set of presentation metadata; and
generate an image based at least in part on the augmented slide.

9. The system of claim 8, wherein the recorded user action comprises a user interaction with respect to a specified element of the slide.

10. The system of claim 1, wherein the processor is further configured to crop the user overlay video based on one or more of: a device type associated with the system, a predetermined shape, and a sized frame.

11. The system of claim 1, wherein the processor is further configured to render the composite media in response to a request to play the composite media, and wherein to overlay the at least portion of the user overlay video on the image including the relevant portion of the set of slides includes to:
output the image at a display screen associated with the system; and
output the user overlay video over the image at a designated offset relative to the image.

12. The system of claim 1, wherein the processor is further configured to render the composite media in response to a request to export the composite media, and wherein to overlay the at least portion of the user overlay video on the image including the relevant portion of the set of slides includes to:
overlay the user overlay video at a designated offset relative to the image; and
generate a video file by generating one or more video frames from overlaying the user overlay video at the designated offset relative to the image.

13. The system of claim 12, wherein the overlaying the user overlay video at the designated offset relative to the image is not presented at a display screen associated with the system.

14. A method, comprising:
storing a composite media including a set of slides, a user overlay video, and a set of presentation metadata, wherein the set of presentation metadata relates one or more slides to the user overlay video; and
rendering the composite media including:
using the set of presentation metadata to generate an image including a relevant portion of the set of slides; and
overlaying at least a portion of the user overlay video on the image including the relevant portion of the set of slides.

15. The method of claim 14, wherein using the set of presentation metadata to generate the image including the relevant portion of the set of slides includes:
augmenting a slide of the set of slides based at least in part on a recorded user action that is included in the set of presentation metadata; and
generating an image based at least in part on the augmented slide.

16. The method of claim 15, wherein the recorded user action comprises a user interaction with respect to a specified element of the slide.

17. The method of claim 14, further comprising rendering the composite media in response to a request to play the composite media, and wherein overlaying the at least portion of the user overlay video on the image including the relevant portion of the set of slides includes:
outputting the image at a display screen associated with a system; and
outputting the user overlay video over the image at a designated offset relative to the image.

18. The method of claim 14, further comprising rendering the composite media in response to a request to export the composite media, and wherein overlaying the at least portion of the user overlay video on the image including the relevant portion of the set of slides includes:
overlaying the user overlay video at a designated offset relative to the image; and
generating a video file by generating one or more video frames from overlaying the user overlay video at the designated offset relative to the image.

19. The method of claim 18, wherein the overlaying the user overlay video at the designated offset relative to the image is not presented at a display screen associated with the system.

20. A computer program product, the computer program product being embodied in a non-transitory computer readable storage medium and comprising computer instructions for:
storing a composite media including a set of slides, a user overlay video, and a set of presentation metadata, wherein the set of presentation metadata relates one or more slides to the user overlay video; and
rendering the composite media including:
using the set of presentation metadata to generate an image including a relevant portion of the set of slides; and
overlaying at least a portion of the user overlay video on the image including the relevant portion of the set of slides.
